(19) United States
(12) Patent Application Publication
(10) Pub. No.: US 2007/0159712 A1
(43) Pub. Date: Jul. 12, 2007

(54) Electronic Drop Protection System of External Hard-Disk Box

(75) Inventor: Macro Chen, Taoyuan County (TW)

Correspondence Address: WPAT, PC, 7225 BEVERLY ST., ANNANDALE, VA, 22003, US

(73) Assignee: MAPOWER ELECTRONICS CO., LTD., Taoyuan County (TW)

(21) Appl. No.: 11/427,084

(22) Filed: Jun. 28, 2006

(30) Foreign Application Priority Data
Jun. 30, 2005 (TW) 094210980

(51) Int. Cl. G11B 21/02

(52) U.S. Cl. 360/75

(57) ABSTRACT

The present invention discloses an electronic drop protection system of external hard-disk box that comprises a first tilt sensor for sensing tilt in a first direction, a second tilt sensor for sensing tilt in a second direction, a external interface for connecting external system, a hard-disk, and a hard-disk bridge module for connecting the hard-disk and the external interface. After receiving tilt notification from the first tilt sensor and/or the second tilt sensor, the bridge module issues a park command to the hard-disk to park the read/write head to safe position in order to prevent collision with the hard-disk.

### BACKGROUND OF THE INVENTION

1. Field of the Invention

The present invention generally relates to an external hard-disk box, and more particularly to an electronic drop protection system of external hard-disk box.

2. Description of the Prior Art

Recently, the external storing apparatus box is popularly used to expand the capacity of the storing apparatus of a computer as a portable storing medium, and there are several sizes of the external storing apparatus box for containing various sizes of the hard-disk and the CD. The familiar sizes of the external storing apparatus box are 2.5, 3.5, or 5.25 inches, and the interfaces of the hard-disk and the CD are usually Parallel ATA, Serial ATA, and varied SCSI interface. The external storing apparatus box provides an interface for connecting with the computer as USB, IEEE 1394, SCSI, and so on, wherein the interface can be inserted in or extracted from the interface of the computer at any time. In addition, the electric fan or the blow hole can be installed in the external storing apparatus box so as to avoid that the storing apparatus is too hot.

The hard-disk in the external storing apparatus box is always broken because of the dropping of the external storing apparatus box, especially the storing data broken by the collision and the friction of the read/write head and the hard-disk. Although the general hard-disk can issue the “Park” command to park the read/write head to safe position in order to prevent collision with the hard-disk, the dropping of the external storing apparatus box is too fast to be simultaneously issued the “Park” command by the external storing apparatus box.

For this reason, there is a demand for an external storing apparatus which can issue “Park” command automatically to prevent the data broken by collision with the read/write head and the hard-disk when the external storing apparatus is dropping.

### SUMMARY OF THE INVENTION

Therefore, in accordance with the previous summary, objects, features and advantages of the present disclosure will become apparent to one skilled in the art from the subsequent description and the appended claims taken in conjunction with the accompanying drawings.

The present invention discloses an electronic drop protection system of external hard-disk box that comprises a first tilt sensor for sensing tilt in a first direction, a second tilt sensor for sensing tilt in a second direction, a external interface for connecting external system, a hard-disk, and a hard-disk bridge module for connecting the hard-disk and the external interface. After receiving tilt notification from the first tilt sensor and/or the second tilt sensor, the bridge module issues a park command to the hard-disk to park the read/write head to safe position in order to prevent collision with the hard-disk.

### BRIEF DESCRIPTION OF THE DRAWINGS

The accompanying drawings incorporated in and forming a part of the specification illustrate several aspects of the present invention, and together with the description serve to explain the principles of the disclosure. In the drawings:

FIG. 1 is a diagram illustrates an electronic drop protection system according to an embodiment of the present invention

### DETAILED DESCRIPTION OF THE PREFERRED EMBODIMENTS

The present disclosure can be described by the embodiments given below. It is understood, however, that the embodiments below are not necessarily limitations to the present disclosure, but are used to a typical implementation of the invention.

Having summarized various aspects of the present invention, reference will now be made in detail to the description of the invention as illustrated in the drawings. While the invention will be described in connection with these drawings, there is no intent to limit it to the embodiment or embodiments disclosed therein. On the contrary the intent is to cover all alternatives, modifications and equivalents included within the spirit and scope of the invention as defined by the appended claims.

It is noted that the drawings presents herein have been provided to illustrate certain features and aspects of embodiments of the invention. It will be appreciated from the description provided herein that a variety of alternative embodiments and implementations may be realized, consistent with the scope and spirit of the present invention.

It is also noted that the drawings presents herein are not consistent with the same scale. Some scales of some components are not proportional to the scales of other components in order to provide comprehensive descriptions and emphasizes to this present invention.

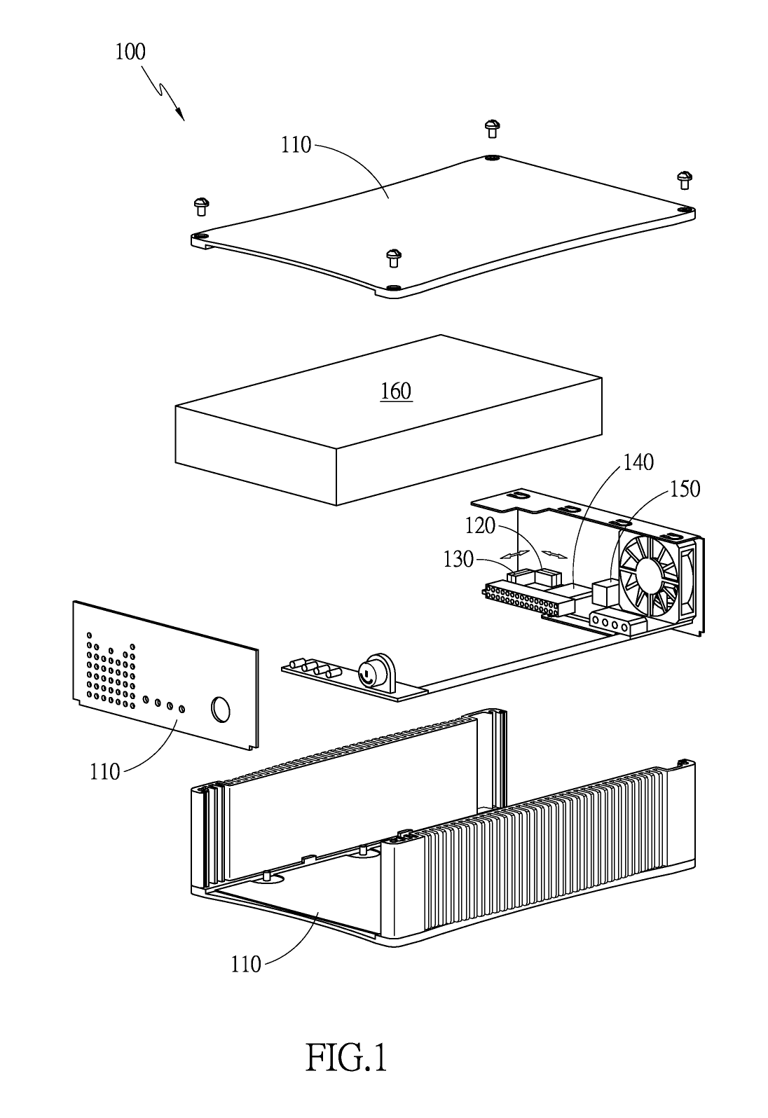

FIG. 1 illustrates a diagram according to an embodiment of the present invention. An electronic drop protection system 100 comprises an external hard-disk box 110, wherein a first tilt sensor 120, a second tilt sensor 130, a hand-disk bridge module 140, an external interface 150, and a hard-disk 160 are built in the external hard-disk box 110. The hand-disk bridge module 140 transmits the electronic signals from the external interface 150 to the hard-disk 160 and transmits the electronic signals from the hard-disk 160 to the external interface 150. According to the embodiment, the specification of the external interface 150 can be IEEE 1394, IEEE 802.11 WLAN, USB, Ethernet, SCSI, etc, and the interface of the hard-disk 160 can be Parallel ATA, Serial ATA, SCSI, optical fiber, and so on. However, it is noted that the external interface and the hard-disk are not limited by the foregoing description.

The first tilt sensor 120 and the second tilt sensor 130 are orthogonal, wherein the first tilt sensor 120 sensors tilt in a first direction, and the second tilt sensor 130 sensors tilt in a second direction. In view of the above, there must be components of force in the first direction and the second direction when the external hard-disk box 110 is moving. Therefore, the first tilt sensor 120 will issue a signal to the hand-disk bridge module 140 when the component of force in the first direction exceeds the sensing limit of the first tilt sensor 120, and so does the second tilt sensor 130. Then the hand-disk bridge module 140 will issue a “Park” command to the hand-disk 160 to park the read/write head to safe position in order to prevent collision with the hard-disk. In view of the above, the storing data of the hard-disk will not be broken by the read/write head scraping the hard-disk surface when the hard-disk is dropping.

The foregoing description is not intended to be exhaustive or to limit the invention to the precise forms disclosed. Obvious modifications or variations are possible in light of the above teachings. In this regard, the embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the inventions as determined by the appended claims when interpreted in accordance with the breath to which they are fairly and legally entitled.

It is understood that several modifications, changes, and substitutions are intended in the foregoing disclosure and in some instances some features of the invention will be employed without a corresponding use of other features. Accordingly, it is appropriate that the appended claims be construed broadly and in a manner consistent with the scope of the invention.

1. An electronic drop protection system of external hard-disk box comprising:
a first tilt sensor for sensing tilt in a first direction;
a second tilt sensor for sensing tilt in a second direction;
a external interface for connecting external system; and
a hand-disk bridge module for connecting said hard-disk and said external interface, wherein said hand-disk bridge module issues a command to said hand-disk to park the read/write head to safe position in order to prevent collision with said hard-disk after receiving tilt notification from said tilt sensor and/or said second tilt sensor.

2. An electronic drop protection system of external hard-disk box of claim 1, wherein said first direction and said second direction are orthogonal.

3. An electronic drop protection system of external hard-disk box of claim 1, wherein said command is a “park” command.
